(19) United States
(12) Patent Application Publication
(10) Pub. No.: US 2018/0161972 A1
(43) Pub. Date: Jun. 14, 2018

(54) SCREWDRIVER TOOL WITH IDENTIFICATION STRUCTURE

(71) Applicant: YUN CHAN INDUSTRY CO., LTD., New Taipei City (TW)

(72) Inventor: FU-JUI HSIAO, NEW TAIPEI CITY (TW)

(21) Appl. No.: 15/373,468

(22) Filed: Dec. 9, 2016

(51) Int. Cl. B25G 1/10; B25B 15/02; B25G 1/00; B25B 23/00; B25B 13/46

(52) U.S. Cl. CPC B25G 1/105; B25B 15/02; B25B 13/461; B25B 23/0007; B25G 1/005

(57) ABSTRACT

A screwdriver tool with an identification structure includes: a screwdriver rod, a screwdriver head adapted to insert in and turn a screw being configured on one end thereof, a grip, configured on one end of the screwdriver rod far away from the screwdriver head; and an identification portion, configured on one end of the grip far away from the screwdriver rod, and being a three-dimensional convex-shaped body and corresponding to a shape of the screwdriver head. Whereby, a user may watch the three-dimensional convex shape of the identification portion directly to identify easily and quickly the shape of the screwdriver head.

### TECHNICAL FIELD OF THE INVENTION

The present invention relates to a screwdriver tool with an identification structure capable of indentifying the screwdriver tool quickly and clearly.

### DESCRIPTION OF THE PRIOR ART

Conventional screwdrivers have a variety of types of screwdriver heads corresponding to a variety of types of screws (e.g. single slot head screws, cross-recessed head screws, and etc). However, giving consideration of production cost and other factors, the differences of conventional screwdrivers (including grip) made by manufacturers are only screwdriver heads, and other parts thereof are almost the same. Therefore, it is difficult to distinguish a target type when a variety of conventional screwdrivers are placed together, the only way can be done is picking them up to watch one by one and identifying screwdriver heads, which is very troublesome.

### SUMMARY OF THE INVENTION

The main object of the present invention is to provide a screwdriver tool with an identification structure, convenient for the identification of a user.

To achieve the object mentioned above, the present invention proposes a screwdriver tool with an identification structure, including: a screwdriver rod, a screwdriver head adapted to insert in and turn a screw being configured on one end thereof; a grip, configured on one end of the screwdriver rod far away from the screwdriver head; and an identification portion, configured on one end of the grip far away from the screwdriver rod, and being a three-dimensional convex-shaped body and corresponding to a shape of the screwdriver head. Whereby, a user may watch the three-dimensional convex shape of the identification portion directly to identify easily and quickly the shape of the screwdriver head so as to find a required target among a plurality of screwdrivers according to the present invention.

### BRIEF DESCRIPTION OF THE DRAWINGS

FIGS. 1 and 2 respectively are a perspective view of a preferred embodiment according to the present invention;

FIG. 3 is a schematic view of the embodiment of the present invention;

FIG. 4 is a top view of an identification portion according to the present invention;

FIG. 5 is a schematic view of an auxiliary part of another preferred embodiment of the present invention;

FIG. 6 is an exploded view of still another preferred embodiment of the present invention; and

FIG. 7 is a perspective view of the embodiment shown in FIG. 6, where a ratchet wrench will be coupled to a couple part.

### DETAILED DESCRIPTION OF THE PREFERRED EMBODIMENTS

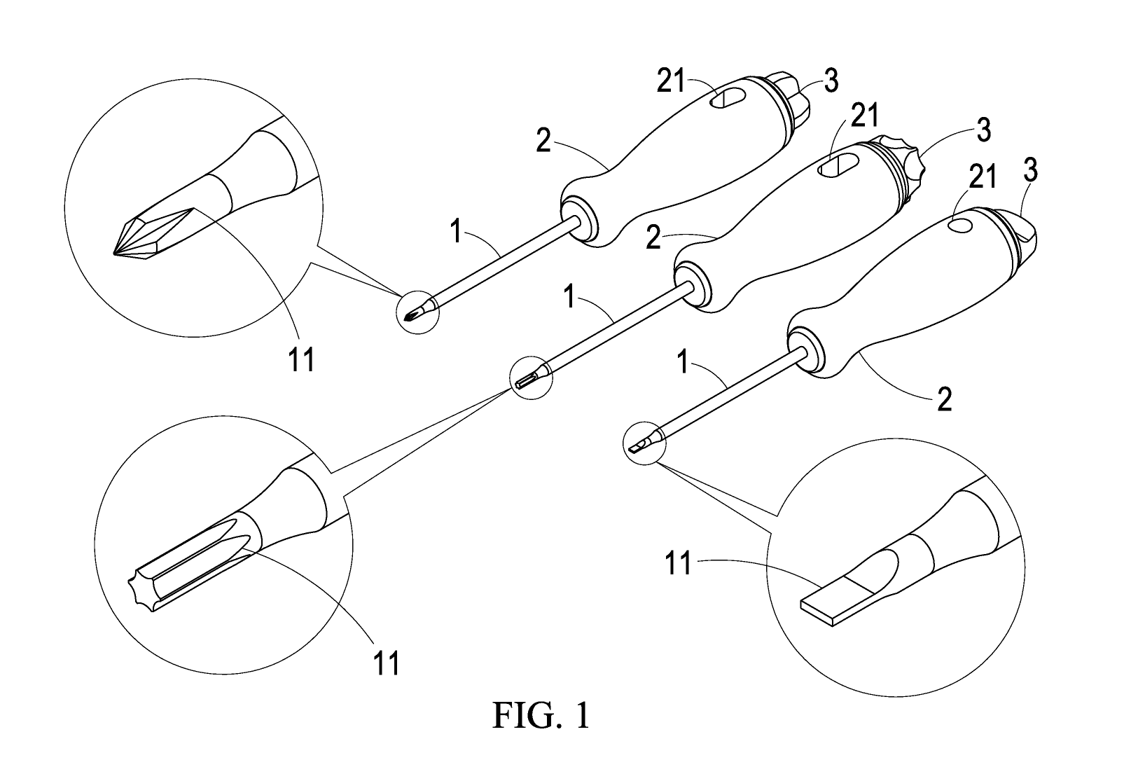

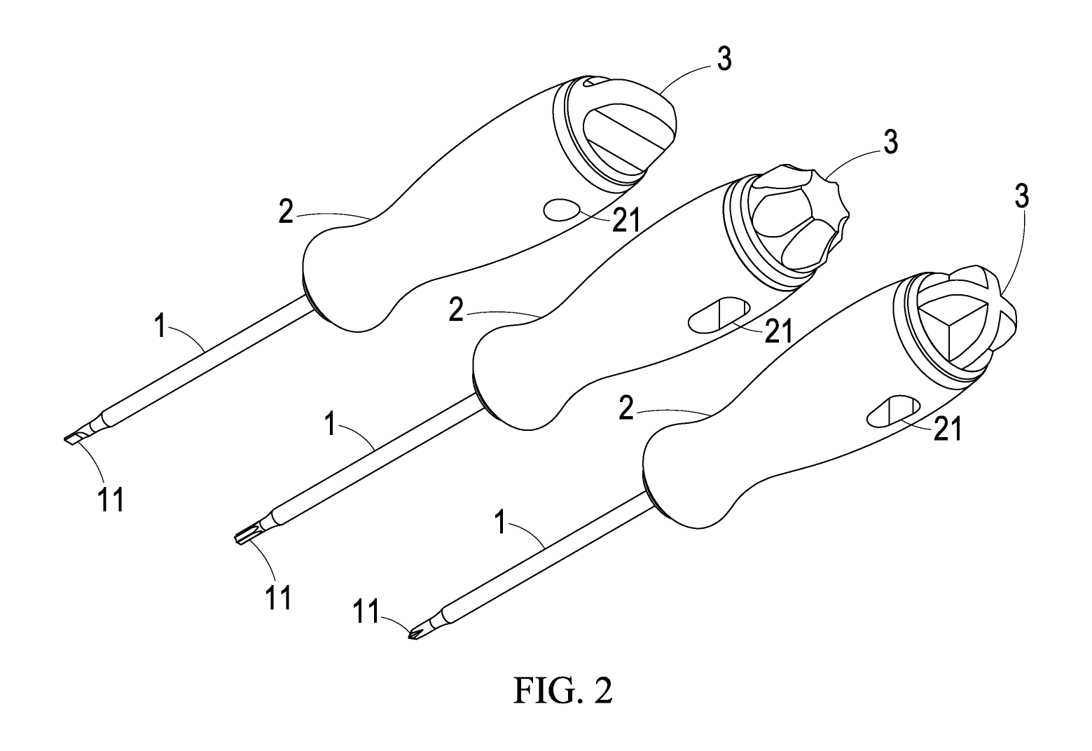

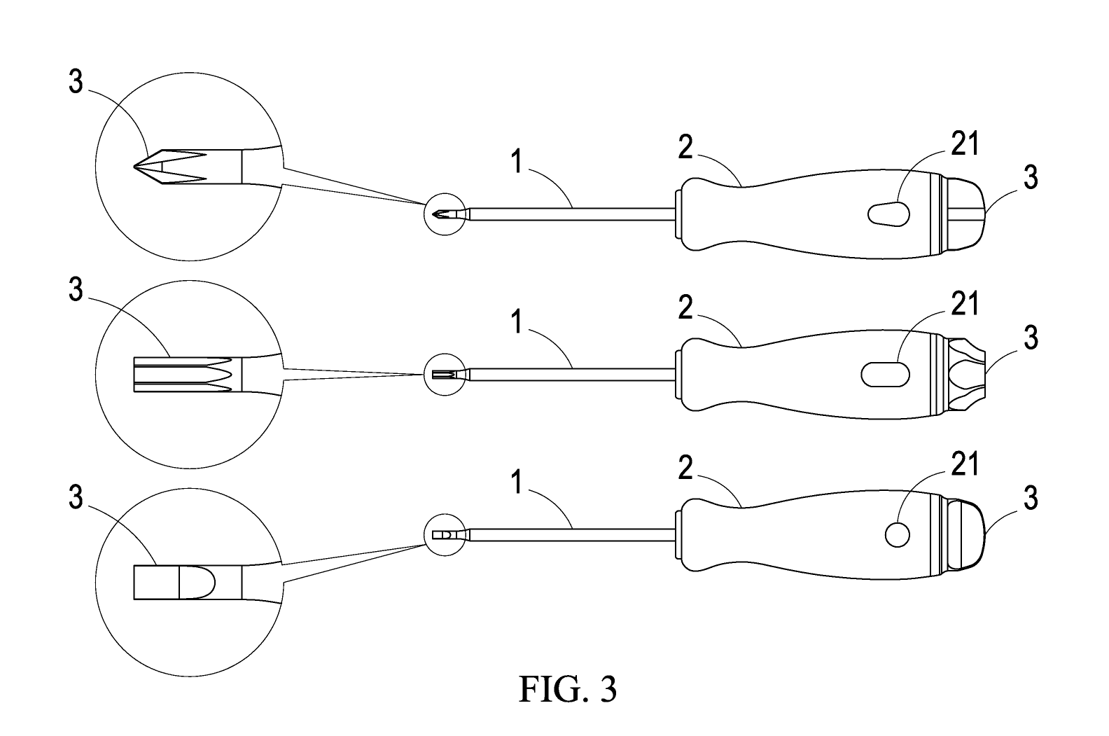

Referring to FIGS. 1 to 3, a screwdriver tool with an identification structure includes a screwdriver rod 1, grip 2 and identification portion 3, where a screwdriver head 11 for the insertion thereof in a screw to turn it is configured on one end of screwdriver rod 1, and the grip 2 is configured on another end of screwdriver rod 1 far away from the screwdriver head 11 and formed with at least one hanging hole 21 to facilitate the hanging of the screwdriver, where the different shapes of the hanging holes may assist in the identification of screwdrivers. The identification portion 3 is configured on one end of grip 2 far away from the screwdriver rod 1, where the identification portion 3 is a three-dimensional convex-shaped object and corresponds to the shape of the screwdriver head for the quick screwdriver identification. The identification portion 3 as well as the screwdriver head 11 has an outlook type such as a slotted, cross slot, pozidriv, torx, security T, hexagon, tri-wing, square or pentagon type; the slotted, cross slot and torx types are exemplarily shown in the figures.

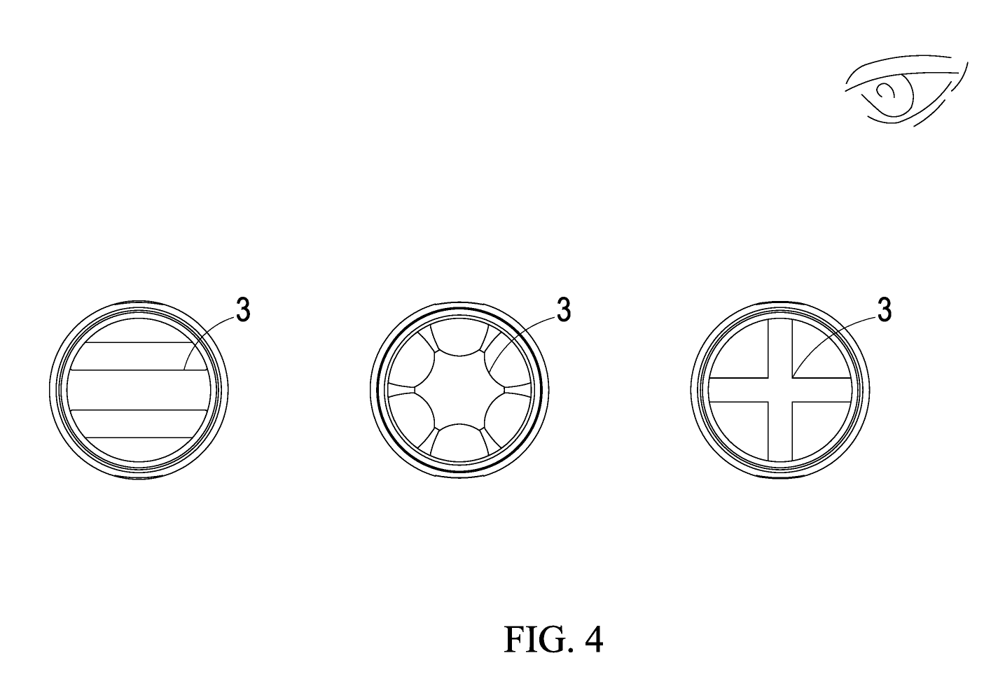

Referring to FIGS. 1 to 4, when a plurality of screwdrivers according to the present invention are placed together, a user may watch the three-dimensional convex shape of the identification portion 3 directly from each angle, and can identify easily and quickly the shape of the screwdriver head 11 through the three-dimensional convex shape so that the target screwdriver can be picked up quickly, thereby avoiding the trouble of and saving the time of searching it one by one. In addition, the influence of dirt and the like to the identification is reduced through the design of the three-dimensional convex shape.

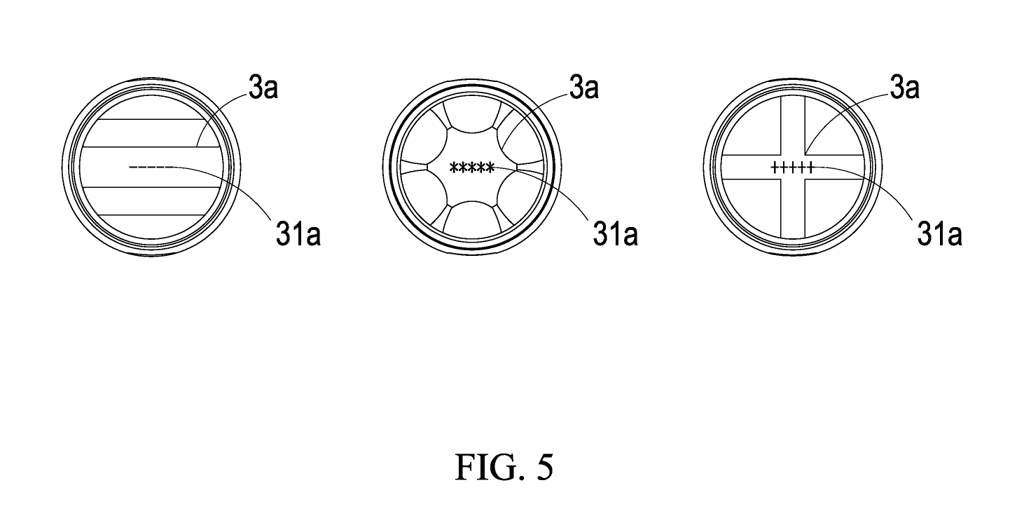

Referring to FIG. 5, which shows another preferred embodiment of the present invention, the present embodiment is almost similar to the embodiment mentioned above, the only difference is that an auxiliary part 31a may be configured on the identification portion and has color, size, characters, symbol or code to assist the identification. For example, symbols are exemplarily used as shown in the figure.

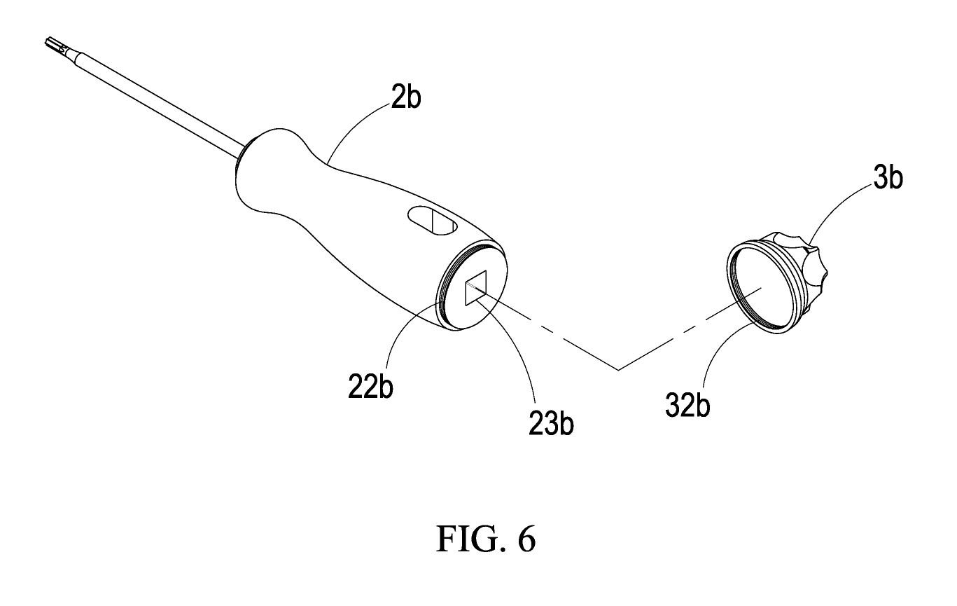

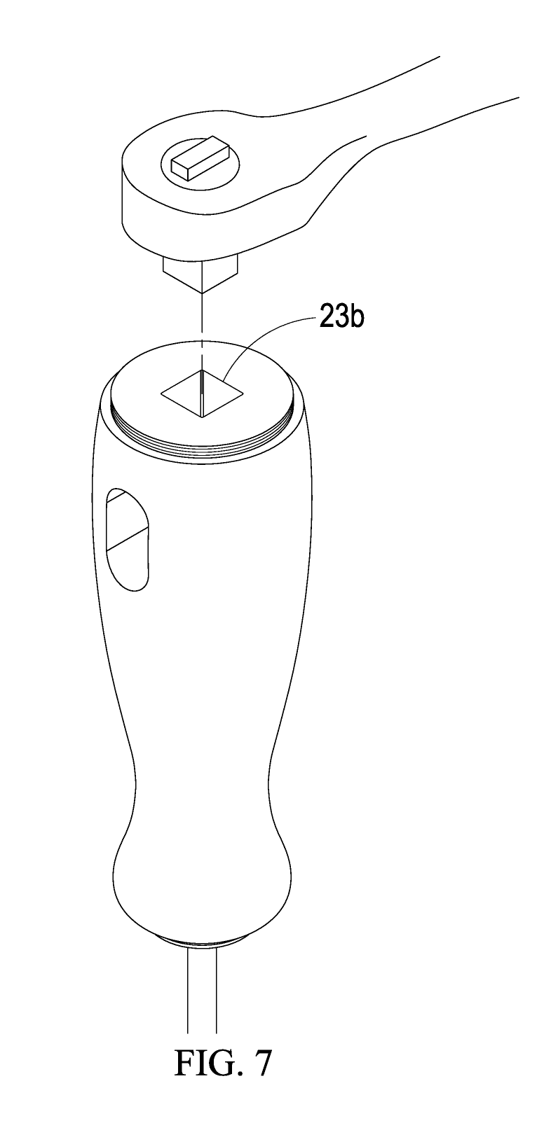

Referring to FIGS. 6 and 7, which shows still another preferred embodiment of the present invention, the present embodiment is almost similar to the embodiments mentioned above, and the only difference is that the identification portion 31b may be separated from the grip 2b in the present embodiment. At least one connection part 32b is configured on one side of the identification portion 3b adjacent to the grip 2b, and at least one connection part 22b corresponding to the connection part 32b is configured on the grip 2b, where the connection part 32b is coupled to the connection part 22b by means of engagement, locking, buckling, or the same. In addition, at least one coupling part 23b for the coupling of an auxiliary device to the grip 2b is configured on one side of the grip 2b adjacent to the identification portion 3b, where the auxiliary device is a ratchet wrench or hexagonal wrench, thereby allowing a user to use the auxiliary device to assist in the rotation of a screwdriver to enable the use to be more easy and labor-saving. For example, a ratchet wrench is exemplarily used as FIG. 7 shows.

I claim:

1. A screwdriver tool with an identification structure, comprising:
a screwdriver rod, a screwdriver head adapted o insert in and turn a screw being configured on one end thereof;
a grip, configured on one end of said screwdriver rod far away from said screwdriver head; and
an identification portion, configured on one end of said grip far away from said screwdriver rod, and being a three-dimensional convex-shaped body and corresponding to a shape of said screwdriver head, thereby allowing the quick identification of said screwdriver tool of a user.

2. The screwdriver tool according to claim 1, wherein a hanging hole is configured on said grip.

3. The screwdriver tool according to claim 1, wherein at least one auxiliary part is configured on said identification portion.

4. The screwdriver tool according to claim 3, wherein said auxiliary part has color, size, characters, or code.

5. The screwdriver tool according to claim 1, wherein said identification portion as well as said screwdriver has a slotted, cross slot, pozidriv, torx, security T, hexagon, tri-wing, square or pentagon type.

6. The screwdriver tool according to claim 1, wherein said identification portion is separated from said grip.

7. The screwdriver tool according to claim 6, wherein at least one connection portion is configured on one end of said identification portion adjacent to said grip, and at least one connection part corresponding to said connection portion of said identification portion is configured on one end of said grip.

8. The screwdriver tool according to claim 7, wherein said connection part of said identification portion is coupled to said connection part of said grip by means of engagement, locking or buckling.

9. The screwdriver tool according to claim 6, wherein at least one coupling part for the coupling an auxiliary device to said grip is configured on one end thereof adjacent to said identification portion.

10. The screwdriver tool according to claim 9, wherein said auxiliary device is a ratchet wrench or hexagonal wrench.
